(19) United States
(12) Patent Application Publication
(10) Pub. No.: US 2022/0146062 A1
(43) Pub. Date: May 12, 2022

(54) METHOD AND APPARATUS FOR PRESSING A STRIP-LIKE ELEMENT ON TO THE INNER SURFACE OF THE SIDE WALL OF A TUBE

(71) Applicant: EID ROBOTICS OY, Kuopio (FI)

(72) Inventors: Paavo KÄKELÄ, Tupos (FI); Jari HELMINEN, Kuopio (FI); Jyri JÄÄSKELÄINEN, Kuopio (FI); Mika HÄTINEN, Kuopio (FI)

(21) Appl. No.: 17/436,913

(22) PCT Filed: Mar. 7, 2019
(86) PCT No.: PCT/FI2019/050181

§ 371 Date: Sep. 7, 2021

(51) Int. Cl. F21S 4/28; F21K 9/90; F21V 19/00

(52) U.S. Cl. CPC F21S 4/28; F21Y 2115/10; F21V 19/005; F21K 9/90

(57) ABSTRACT

The invention relates to a method for pressing strip-like element (12) onto the inner surface of the side wall of a tube (11) having an open end in which method: —a strip like element (12) is secured on the outer surface of a rod-like element (13) being fittable inside the tube (11) through its open end; —the rod-like element is fitted movably at least partly inside the tube; —rod-like element (13) is moved transversally in the tube (11) such that the rod-like element (13) presses the strip-like element (12) against the inner surface of the side wall of the tube (11). In the method according to the invention the rod-like element (13) is at least partly ferromagnetic rod-like element (13) and magnetic force effecting on the at least partly ferromagnetic rod-like element (13) is formed at least into inner side of the tube (11) such that it moves the at least partly ferromagnetic rod-like element (13) transversally towards the portion of the inner surface of the tube (11) being opposite the strip like-element (12) such that the strip-like element (12) is pressed against the inner surface of the side wall of the tube (11). The invention relates also to an apparatus (10) for carrying out the method according to the invention.

### FIELD OF THE INVENTION

The invention relates to a method and apparatus for pressing a strip-like element on to the inner surface of the side wall of a tube.

### BACKGROUND OF THE INVENTION

Presently, there are applications in industry wherein a strip-like element has to be attached on to the inner surface of a side wall of a tube e.g. by means of adhesive bonding. A rapidly growing application wherein such method is used relates to the manufacturing process of LED light tubes i.e. light tubes wherein LED light strips are used as light source instead of a fluorescent lamps. In such application a paper or plastic strip-like element with plurality of light emitting diodes (LEDs) being mounted one after another on to the strip-like element is fitted in to a transparent light tube (i.e. made of e.g. a glass or plastic or corresponding translucent material) and glued in to the inner surface of the side wall of the light tube. During the bonding phase the LED light strip has to be pressed against the inner surface of the LED light tube. Presently, the pressing phase is carried out by means of a pressing bar or rod which has smaller diameter than the inner diameter of the light tube. The bar or rod with a LED light strip (with clue in its back side) is fitted in to the light tube. Thereafter, the bar or rod (which is hold from its end that remains outside the light tube) is moved radially inside the light tube such that the LED light strip is pressed against the inner surface of the LED light tube. A drawback of this known method is that by using such a pressing bar or rod it is difficult to accomplish evenly distributed compression force along the LED light strip in the LED light tube. This may lead incomplete sticking of the LED light strip on to the inner surface of the LED light tube.

### BRIEF DESCRIPTION OF THE INVENTION

The aim of the invention is to provide a method and apparatus for pressing a strip-like element on to the inner surface of the side wall of a tube wherein evenly distributed compression force along the strip like element is achieved. Especially, the aim of the invention is to provide a novel method and apparatus for pressing a strip-like element on to the inner surface of the side wall of a tube which is applicable in manufacturing process of LED light tubes.

The aim of the invention is achieved by a method and apparatus wherein an at least partly ferromagnetic rod-like element is used as a rod or bar for pressing the strip-like element on to the inner surface of the side-wall of a tube such that the at least partly ferromagnetic rod-like element holding the strip-like element on its outer surface being fitted in to the tube is moved and compressed against the inner surface of the side wall of the tube by means of magnetic force formed at least in to the tube moving and pressing the at least partly ferromagnetic rod-like element with the strip-like element secured at least temporarily on its outer surface against the inner surface of the side wall of the tube. To put it more precisely, the method according to the invention is characterized in what is presented in the independent claim 1 and the apparatus according to the invention is characterized in what is presented in the independent claim 14. Some advantageous embodiments of the method and apparatus according to the invention are presented in independent claims 2 to 13 and 15-20 respectively.

The advantage of the method and apparatus according to the invention is that the strip-like element can be pressed against the inner surface of the side wall of a tube by a pressing force that is evenly distributed along the strip-like element. Furthermore, the advantage of the method is that it is fast and easily controllable and especially suitable for tubes that are made of non-ferromagnetic materials such as glass or plastic tubes and thus the method is very well applicable e.g. in manufacturing process of LED light tubes wherein LED light strips have to be pressed in to the inner surface of the LED light tubes in their bonding phase.

### BRIEF DESCRIPTION OF THE DRAWINGS

In the following, the invention is described in more detail with reference to the appended drawings, in which

FIG. 1 is side view of a LED light tube and the rod before the rod with the LED light strip has been fitted in to the light tube;

FIG. 2 is a side view of a LED light tube and the rod according to FIG. 1 during the fitting of the rod with the LED light strip in to the LED light tube; and

FIG. 3 is a side view of a LED light tube and the at least partly ferromagnetic rod-like element according to previous figures when the rod has been fitted in to the LED light tube and when the rod and LED strip therein is pressed against the inner wall of the LED light tube.

### DETAILED DESCRIPTION OF SOME PREFERRED EMBODIMENTS OF THE INVENTION

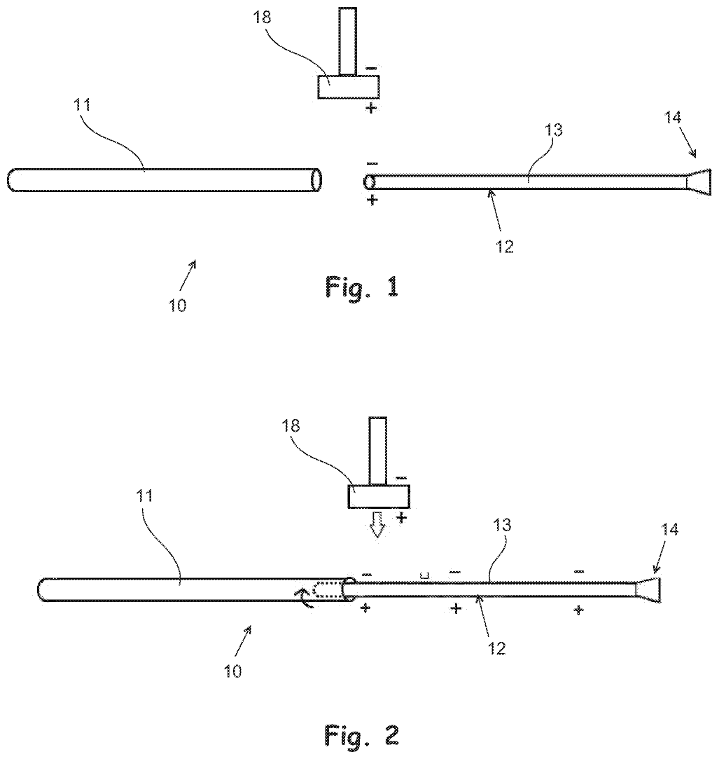

FIGS. 1 to 3 shows three phases of the method according to an embodiment of the invention wherein a strip-like element is fitted in to a tube and pressed on to the inner surface of the tube by means of an at least partly ferromagnetic rod-like element. In case of the embodiment of the method shown in the FIGS. 1 to 3 the strip-like element is a LED light strip 12 and the tube is a LED light tube 11. However, in the other embodiments of the method the strip-like element may be some other strip-like element e.g. a sealing strip for sealing a crack in a plastic or composite tube or pipe such as e.g. water supply, sewage, ventilation or vacuum cleaner tube.

In the FIGS. 1-3 an embodiment of the apparatus 10 according the invention is shown. The apparatus 10 comprises an at least partly ferromagnetic rod-like element that can be fitted in to the LED light tube 11 for pressing the LED light strip 12 on the inner surface of the LED light tube 11. In this embodiment the at least partly ferromagnetic rod-like element is a rod 13 made of magnetic material, preferably a rod made of some suitable permanent magnet material. However, in the other embodiments it can be e.g. a rod, bar or tube made of some non-magnetic material, such as carbon fibre, composite, plastic or aluminium and provided with two or more magnets or pieces of magnetic material such a way in connection with the rod, bar or tube that it is possible by means the magnetic field to cause force acting substantially evenly along the length of the rod, bar or tube.

On the outer surface of the rod 13 there is securing means for holding the LED light strip 12 at least temporarily on the outer surface of the rod 13. Securing means may comprise e.g. some sticker tape to which the LED light strip 12 can be temporarily attached or a suction channel connected to a plurality of holding apertures arranged longitudinally one after another on to the outer surface of the rod 13. Thus, by the latter the LED light strip 12 can be held on the outer surface of the rod 13 by means vacuuming device forming vacuum in to the suction channel of the rod 13.

The apparatus shown in the FIGS. 1-3 comprises also a rod-like element moving device 14 for fitting the rod 13 at least partly into the LED light tube 11 through an open end of the LED light tube 11 as well as moving the rod 13 into the inner side of the LED light tube 11 such that it presses the LED light strip 12 against the inner surface of the side wall of the LED light tube 11. Alternatively or in addition, the LED light tube can be moved in respect of the rod 13. The rod-like element moving device 14 may be e.g. some manipulator or robot which holds and moves the rod 13 in respect of the LED light tube 11 such that the different phases of the process can be carried out. Furthermore, the rod-like element moving device 14 comprises at least one magnet 15 for forming magnetic force effecting on the rod 13 such that it moves the rod 13 transversally towards the portion of the inner surface of the LED light tube 11 being opposite the LED light strip 12 such that the LED light strip 12 is pressed against the inner surface of the side wall of the LED light tube 11. The rod-like element moving device 14 is preferably automatically controlled such that each phases will be carried out automatically. In case if the LED light tube 11 is moved and the rod 13 is held stationary the rod 13 can be attached fixedly to the frame of the apparatus 10. Thus, in such embodiment the apparatus 10 comprises LED light tube moving device which may also be some manipulator or corresponding device having a moving end which holds the LED light tube 11 and moves it towards the rod 13 in direction parallel to the longitudinal direction of the rod 13 until the rod 13 is at least partly inside the LED light tube 11.

For controlling the rod-like element moving device 14 as well as the other functions of the apparatus the apparatus 10 comprises a control system which includes a control unit being connected to the actuators of the different devices of the apparatus 10 such that the control unit can control all of these actuators automatically. The control unit may be e.g. some programmable controller or computer to which a control program can be installed and in which the program can be executed to control the actuators of the apparatus automatically according to an embodiment of the method according to the invention.

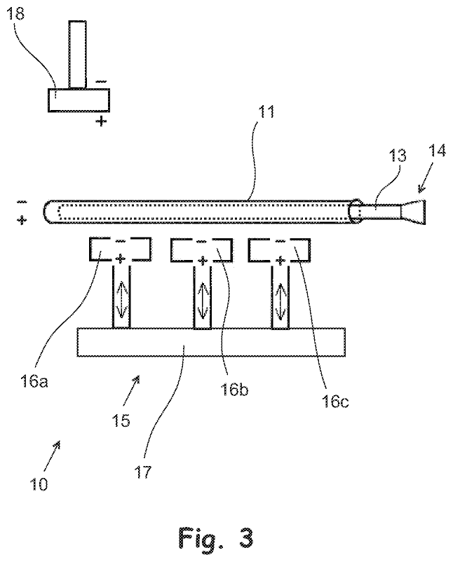

In an embodiment of the apparatus according to the invention the at least partly ferromagnetic rod-like element comprises two or more pieces of ferromagnetic material being aligned with the two or more magnet elements of the at least one magnet 15. In case of the embodiment of FIGS. 1 to 3 the at least one magnet is a magnet device 15 comprising non-magnetic supporting structure 17 which supports three magnet elements 16a-16c one after another in parallel configuration to the rod 13 as it is shown in the FIG. 3. However, in some other embodiment the at least one magnet may be e.g. a single magnetic bar or rod being arranged parallel to the rod 13 or other kind of at least partly ferromagnetic rod-like element.

In an embodiment of the apparatus according to the invention at least one magnet is electromagnet that is connected to an DC source. In such embodiment the apparatus comprises switching device for connecting and disconnecting electric current from the DC source to the at least one electromagnet. Also the electromagnet can be formed of two or more electromagnet elements being arranged in connection of a non-magnetic rod, bar or beam holding the electromagnets one after another in linear configuration such as shown in the FIG. 3. The rod, bar or beam forming a supporting frame for supporting the electromagnet in such position that magnetic force can be formed at least in to the tube (e.g. in to the LED light tube 11 of FIGS. 1 to 3) in to which inner surface the strip-like element (e.g. the LED light strip 12 of FIGS. 1 to 3) is pressed. Thus, the electromagnet or it's electromagnet elements have been aligned with the tube and the rod-like element at least during the time when the rod-like element is pressed against the inner surface of the side-wall of the tube.

In an embodiment of the method shown in the FIGS. 1 to 3 the LED light strip 12 is secured on the outer surface of the rod 13 being fittable inside the LED light tube 11 through the open end as it is shown in the FIG. 1. Thereafter, as shown in the FIG. 2, the rod 13 is fitted movably at least partly inside the LED light tube 11. This may happen by moving the rod 13, the LED light tube 11 or both of them. Next, (as shown in the FIG. 3) the rod 13 is moved transversally in the LED light tube 11 by means magnetic force formed by the three magnet elements 16a-16c of the magnet device 15 such that the rod 13 presses the LED light strip 12 against the inner surface of the side wall of the LED light tube 11.

As can be seen from the FIG. 1, in the first phase, the rod 13 is outside the LED light tube 11. In this phase, a suitable other arrangement such as another manipulator places the LED light strip 12 on the outer surface of the rod 13 wherein it is held by the holding means as described above. In the second phase the rod 13 with the LED light strip 12 on its outer surface is moved in to the LED light tube 11 through its open end such that the rod 13 does not touch the inner surface of the side wall of the LED light tube 11. During this phase, the rod 13 may be supported by a supporting magnet 18 as it is shown in the FIG. 2. The supporting magnet 18 forms magnetic force effecting preferably at least on to the end of the rod 13 such that the free end of the rod 13 can be appropriately fitted into the LED light tube 11 through the open end of the LED light tube 11. During this fitting phase the free end of the rod 13 is held on the side of the LED light tube 11 such that the LED light strip does not touch to the inner surface of the side-wall of the LED light tube. In the third phase the rod-like element moving device 14 holds the rod 13 in the LED light tube 11 and moves it transversally in the direction of the portion of the side wall of the LED light tube 11 that is opposite the LED light strip 12 being held on the outer surface of the rod 13. Alternatively or in addition the LED light tube 11 can be moved transversally in corresponding manner. Especially if only the LED light tube 11 is moved then the rod 13 is held stationary by means of a support structure being fixedly attached to the frame of the apparatus 10. The advantage of such embodiment is that the supporting magnet 18 need not to be moved with the rod 13 as the case is when only the rod 13 is moved and the LED light tube 11 is held stationary. Simultaneously or after when the rod 13 is moved in respect to the LED light tube 11, magnetic force effecting on to the rod 13 is formed by the magnet device 15 at least into inner side of the LED light tube 11 such that it moves the rod 13 transversally towards the portion of the inner surface of the side wall of the LED light tube 11 being opposite the LED light strip 12. Thus, the LED light strip 112 is pressed against the inner surface of the side wall of the LED light tube 11. The pressing force is thus evenly distributed along the length of the rod 13 being in contact with the inner surface of the side-wall of the LED light tube.

In this embodiment the aim of the process is to glue the LED light strip 12 on the inner surface of the side wall of the LED light tube 11. Thus, the LED light strip 12 includes suitable adhesive on its outer surface which such that LED light strip 12 is bonded on to the inner surface of the LED light tube 11 during pressing. The adhesive may be added on the outer surface of the LED light strip, for instance after it has been secured on the outer surface of the rod 13. Anyway, due to the evenly distributed pressing force achieved by the method according to the invention the quality of the adhesive joint between the LED light tube 11 and the LED light strip 12 is significantly improved.

The magnetic field forming the magnetic force moving the rod 13 may be formed by means of at least one magnet arranged in connection with the rod 13 and/or by means of at least one magnet arranged outside the tube 11. In the embodiment of FIGS. 1 to 3 the magnet device 15 is outside the LED light tube 11. Thus, the magnetic field is formed also outside the LED light tube 11.

In case of the method according to the embodiment shown in the FIGS. 1 to 3 the magnetic field is formed by means of at least one permanent magnet. In the embodiment of FIGS. 1 to 3 the alt least one magnet is a magnet device 15 comprising three permanent magnet elements 16a-16c. The magnet device 15 is moved towards the rod 13 to increase the magnetic force effecting on to the rod 13. To decrease the magnetic force effecting on to the rod 13 the magnet device 15 is moved apart from the rod 13. Movements of the magnet device 15 can be accomplished by a magnet moving device. The magnet moving device may comprise a suitable support frame to which a linear actuator such as linear motor or pneumatic cylinder is secured. The support frame can be attached to the frame of the apparatus such that the moving end of the linear motor can be moved back and worth towards and away from the LED light tube 11 as it is shown in the FIG. 3. Thus, by attaching the magnet device 15 at the moving end of the linear motor the magnet elements 16a-16c can be moved towards and away from the rod 13 being fitted in to the LED light tube 11.

In an embodiment of the method, the at least one permanent magnet is rotated to change the strength and/or direction of the magnetic force effecting on the at least partly ferromagnetic rod-like element. In the embodiment of the FIGS. 1 to 3 rotation can be arranged by a turning means at the end of the moving end of the linear actuator of the magnet moving device moving the magnet elements 16a-16c closer to or further apart from the LED light tube 11. The turning means may include some suitable rotator which may comprise, for instance, an electric motor with a worm gear for reducing the rotating speed of the motor to suitable turning speed for turning the magnet elements 16a-16c in appropriate way.

In an embodiment of the method the magnetic field is formed by means of at least one electromagnet. However, in such embodiment there may be also permanent magnets in addition to the at least one electromagnet. In such embodiment where only electromagnets are applied the magnet moving device may be replaced with stationary magnet supporting frame which supports the at least one electromagnet in fixed position within a distance from the tube (e.g. from the LED light tube 11). Nevertheless, in some other embodiment wherein the at least one magnet is a electromagnet the apparatus may also comprise corresponding magnet moving device as in case when the at least one magnet is formed of one or more permanent magnets or separate magnet elements supported by a magnet supporting frame. When one or more electromagnets is applied electric current is connected to the electromagnets to switch the magnetic field on and to cause the magnetic force to effect on to the at least partly ferromagnetic rod-like element such as the rod 13. At the end of pressing phase electric current is disconnected from the at least one electromagnet to switch the magnetic field off and to release the magnetic force effecting on to the at least partly ferromagnetic rod-like element. For instance in such embodiments as the embodiment of the FIGS. 1 to 3, in order to ensure that the rod 13 detaches from the LED light strip 12 the direction of the current in the electromagnet may be changed to change the direction of the magnetic force effecting on to the rod 13. Preferably, these method steps can be carried out automatically by a switch or corresponding control device being controlled by the control unit of the system.

Furthermore, the method and system according to the invention may be realized in many ways differing from the embodiments described above. For example, instead of rotating the at least one magnet the tube and/or the rod-like element can be arranged to be rotatable in respect its longitudinal axis to change the direction of the magnetic force and or the position of the tube against which the strip-like element is pressed. This is the case if the at least one magnet is part of or has been arranged in connection with the at least partly ferromagnetic rod-like element. In such case there may be also at least one magnet that is hold outside the tube. Thus, with such arrangement either attractive or repelling magnetic forces can be applied for pressing the rod-like element on to the inner surface of the side wall of the tube. In such embodiments as shown in the FIGS. 1 to 3 which have magnets outside the LED light tube and also in connection with the rod-like element it is possible to use attractive magnetic force to press the LED light strip on to the inner surface of the side-wall of the LED light tube and repelling force to detach the rod from the LED light strip after the pressing phase or vice versa. Thus, it is also possible to use magnet device of such arrangement as a supporting magnet during the phase when the rod is fitted in to the LED light tube.

Consequently, the method and apparatus according to the invention should not be limited to the embodiments described above but they can vary within the scope of the attended claims.

1. A method for pressing strip-like element (12) on to the inner surface of the side wall of a tube (11) having an open end in which method:
a strip like element (12) is secured at least temporarily on the outer surface of a rod-like element (13) being fittable inside the tube (11) through its open end;
the rod-like element is fitted movably at least partly inside the tube;
rod-like element (13) is moved transversally inside the tube (11) in respect of the tube (11) such that the rod-like element (13) presses the strip-like element (12) against the inner surface of the side wall of the tube (11), characterized in that the rod-like element (13) is at least partly ferromagnetic rod-like element (13), and that magnetic force effecting on the at least partly ferromagnetic rod-like element (13) is formed at least into inner side of the tube (11) such that it moves the at least partly ferromagnetic rod-like element (13) transversally towards the portion of the inner surface of the tube (11) being opposite the strip like-element (12) such that the strip-like element (12) is pressed against the inner surface of the side wall of the tube (11).

2. The method according to the claim 1 wherein the magnetic field is formed by means of at least one magnet (15) arranged in connection with the at least partly ferromagnetic rod-like element (13) and/or by means of at least one magnet (15) arranged outside the tube (11).

3. The method according to the claim 1 or 2 wherein the magnetic field is formed by means of at least one permanent magnet (16a-16c).

4. The method according to claim 3 wherein the at least one permanent magnet (16a-16c) is moved towards the at least partly ferromagnetic rod-like element (13) to increase the magnetic force effecting to the at least partly ferromagnetic rod-like element (13).

5. The method according to claim 3 or 4 wherein the at least one permanent magnet (16a-16c) is moved apart from the at least partly ferromagnetic rod-like element (13) to decrease the magnetic force effecting to the at least partly ferromagnetic rod-like element (13).

6. The method according to any of claims 3 to 5 wherein the at least one permanent magnet (16a-16c) is rotated to change the strength and/or direction of the magnetic force effecting on the at least partly ferromagnetic rod-like element (13).

7. The method according to claims 1 to 6 wherein the magnetic field is formed by means of at least one electromagnet.

8. The method according to claim 7 wherein electric current is connected to the electromagnet to switch the magnetic field on and to cause the magnetic force to effect on to the at least partly ferromagnetic rod-like element (13).

9. The method according to claim 7 or 8 wherein electric current is disconnected from the at least one electromagnet to switch the magnetic field off and to release the magnetic force effecting on to the at least partly ferromagnetic rod-like element (13).

10. The method according to any of claims 7 to 9 wherein the direction of the current in the electromagnet is changed to change the direction of the magnetic force effecting on the at least partly ferromagnetic rod-like element (13).

11. The method according to any of claims 1 to 10 wherein the at least partly ferromagnetic rod-like element (13) is supported and guided in to the tube (11) in the fitting phase by at least one supporting magnet (18).

12. The method according to any of claims 1 to 11 wherein the tube (11) is a LED light tube.

13. The method according to any of claims 1 to 12 wherein the strip-like element (12) is a LED light strip.

14. An apparatus (10) for pressing strip-like element (12) on to the inner surface of the side wall of a tube (11) having an open end, which arrangement comprises:
a rod-like element (13) being fittable in to the tube (11) through its open end for pressing a strip like element (12) on the inner surface of the tube (11);
securing means for securing a strip-like element (12) at least temporarily on the outer surface of the rod-like element (13);
a rod-like element (13) moving device for fitting the rod-like element (13) at least partly into the tube (11) through its open end as well as moving the rod-like element (13) transversally inside the tube (11) in respect of the tube (11) such that the rod-like element (13) presses the strip-like element (12) against the inner surface of the side wall of the tube (11);
characterized in that the rod-like element (13) is a at least partly ferromagnetic rod-like element and that the rod-like element moving device (14) comprises at least one magnet (15) for forming magnetic force effecting on the at least partly ferromagnetic rod-like element (13) such that it moves the at least partly ferromagnetic rod-like element (13) transversally towards the portion of the inner surface of the tube (11) being opposite the strip like-element (12) such that the strip-like element (12) is pressed against the inner surface of the side wall of the tube (11).

15. The apparatus (10) according to claim 14 wherein the apparatus comprises magnet moving device for moving the at least one magnet (15) or at least one magnetic element (16a-16c) towards and away from at least partly ferromagnetic rod-like element (13).

16. The apparatus (10) according to the claim 14 or 15 wherein the at least partly ferromagnetic rod-like element (13) is a rod or bar made of ferromagnetic material.

17. The apparatus (10) according to any of claims 14 to 16 wherein the at least one magnet (15) is a magnetic bar or rod being arranged parallel to the at least partly ferromagnetic rod-like element (13).

18. The apparatus (10) according to any of claims 14 to 17 wherein the at least one magnet (15) is a non-magnetic bar or rod being arranged parallel to the rod-like element and comprising two or more of separate magnet elements (16a-16c) being placed one after another on the non-magnetic bar or rod.

19. The apparatus (10) according to claim 18 wherein the at least partly ferromagnetic rod-like element (13) comprises two or more pieces of ferromagnetic material being aligned with the two or more magnet elements (16a-16c) of the at least one magnet (15).

20. The apparatus (10) according to any of claims 14 to 19 wherein the at least one magnet is electromagnet that is connected to an DC source and wherein the apparatus (10) comprises switching device for connecting and disconnecting electric current from the DC source to the electromagnet.

21. The apparatus (10) according to any of claims 14 to 20 wherein the apparatus (10) comprises at least one supporting magnet (18) for supporting and guiding the rod-like element (13) in to the tube (11) in the fitting phase.
